(19) United States
(12) Patent Application Publication
(10) Pub. No.: US 2017/0175426 A1
(43) Pub. Date: Jun. 22, 2017

(54) ANTI-IMPACT LOCKING FEATURE

(71) Applicant: Checkpoint Systems, Inc., Thorofare, NJ (US)

(72) Inventor: Anthony Piccoli, West Deptford, NJ (US)

(21) Appl. No.: 14/974,966

(22) Filed: Dec. 18, 2015

(51) Int. Cl. E05B 73/00; E05B 41/00; E05B 57/00; E05B 45/00

(52) U.S. Cl. CPC E05B 73/0017; E05B 45/00; E05B 41/00; E05B 73/0041; E05B 73/0064; E05B 57/00

(57) ABSTRACT

In one embodiment, a security device includes a housing; a locking mechanism configured to alternate between a locked state and an unlocked state; a release member configured to alternate between a blocked position and a release position, wherein in the blocked position the release member blocks the locking mechanism from entering the unlocked state; and in the release position the release member allows the locking mechanism to enter the unlocked state; and an electronic article surveillance (EAS) component in a cavity of the housing.

### BACKGROUND

Security devices can be designed to surround a portion of a product to protect the product against theft. But shoplifters continually develop methods for defeating such security devices. For example, in some instances a shoplifter will use mechanical force to mimic the magnetic force provided by a detaches, and thereby remove the security device from the product. There exists a need to improve such security devices to prevent unauthorized removal.

### BRIEF SUMMARY

The present disclosure is directed to an apparatus and method for securing a product. In one aspect, a security device includes a housing comprising a first housing component and a second housing component; a locking mechanism configured to alternate between a locked state and an unlocked state, wherein in the locked state the locking mechanism is configured to lock a first portion of the second housing component to the first housing component and thereby secure the security device to a product and in the unlocked state the first portion of the second housing component is unlocked from and separable from the first housing component thereby enabling removal of the security device from the product; a release member configured to alternate between a blocked position and a release position, wherein in the blocked position the release member blocks the locking mechanism from entering the unlocked state; and in the release position the release member allows the locking mechanism to enter the unlocked state; and an electronic article surveillance (EAS) component in a cavity of the housing.

In another aspect, a method includes placing the security device around a portion of the product, the security device comprising a housing comprising a first housing component and a second housing component; a locking mechanism configured to alternate between a locked state and an unlocked state, wherein in the locked state the locking mechanism is configured to lock a first portion of the second housing component to the first housing component and thereby secure the security device to a product; and in the unlocked state the first portion of the second housing component is unlocked from and separable from the first housing component thereby enabling removal of the security device from the product; a release member configured to alternate between, a blocked position and a release position, wherein in the blocked position the release member blocks the locking mechanism from entering the locked state; and in the release position the release member allows the locking mechanism to enter the locked state; and an electronic article surveillance (EAS) component in a cavity of the housing; attaching the security device to the portion of the product by locking the second housing component to the first housing component: removing the security device from the product by moving the release member to the release position and the locking mechanism to the unlocked state.

In yet another aspect, security device includes a housing comprising a first housing component and a second housing component; a locking member forming part of the first housing component and configured to alternate between a locked position and an unlocked position, the locking member configured to move in a first direction to alternate from the locked position to the unlocked position; wherein in the locked position the locking member is configured to lock a tab of the second housing component to the first housing component and thereby secure the security device to a product; and in the unlocked position the tab of the second housing component is unlocked from and separable from the first housing component thereby enabling removal of the security device from the product; a first biasing member configured to bias the locking member in the locked position; a release member forming part of the first housing component and configured to alternate between a blocked position and a release position, wherein in the blocked position the release member blocks the locking member from moving in the first direction; and in the release position the release member allows the locking member to move in the first direction; a second biasing member configured to bias the release member in the blocked position; and an electronic article surveillance (EAS) component in a cavity of the housing; wherein the first housing component and the second housing component are pivotally coupled via a hinge; wherein the tab of the second housing component is configured to be received by a slot of the first housing component, and the tab comprises a depression configured to receive the locking member; wherein the locking member comprises a transverse portion; wherein in the blocked position the release member blocks the transverse portion of the locking member from moving in the first direction; and wherein in the release position the release member allows the transverse portion of the locking member to move in the first direction.

### BRIEF DESCRIPTION OF THE DRAWINGS

The invention of the present disclosure will become more fully understood from the detailed description and the accompanying drawings, wherein:

FIG. 1 is a perspective view of a security device according to an embodiment of the present disclosure,

FIG. 2 is a perspective view of the first housing component of FIG. 1.

FIG. 3 is a perspective view of the second housing component of FIG. 1.

FIG. 4 is a sectional view of the security device of FIG. 1 taken along line IV.

FIG. 5 is an enlarged view of section V of FIG. 4.

### DETAILED DESCRIPTION

The following description of the preferred embodiment(s) is merely exemplary in nature and is in no way intended to limit the invention or inventions. The description of illustrative embodiments is intended to be read in connection with the accompanying drawings, which are to be considered part of the entire written description. In the description of the exemplary embodiments disclosed herein, any reference to direction or orientation is merely intended for convenience of description and is not intended in any way to limit the scope of the present invention. Relative terms such as “lower,” “upper,” “horizontal,” “vertical,” “above,” “below,” “up,” “down,” “left,” “right,” “top,” “bottom,” “front” and “rear” as well as derivatives thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation unless explicitly indicated as such. Terms such as “attached,” “affixed,” “connected,” “coupled,” “interconnected,” “secured” and other similar terms refer to a relationship wherein structures are secured or attached to one another either directly or indirectly through intervening structures, as well as both movable or rigid attachments or relationships, unless expressly described otherwise. The discussion herein describes and illustrates some possible non-limiting combinations of features that may exist alone or in other combinations of features. Furthermore, as used herein, the term “or” is to be interpreted as a logical operator that results in true whenever one or more of its operands are true.

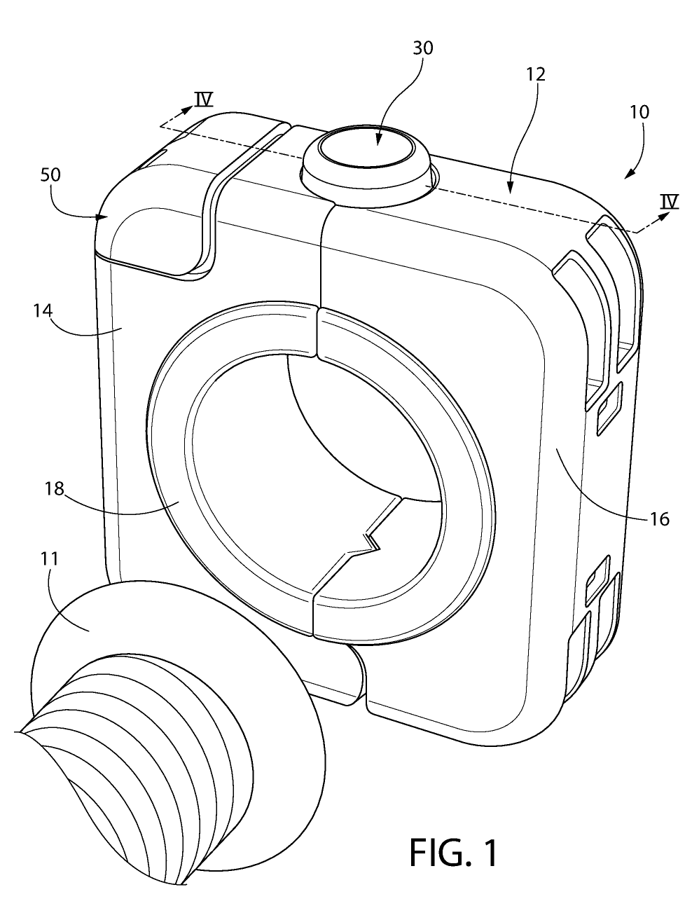

Referring now to the drawings, FIG. 1 is a perspective view of a security device 10 according to an embodiment of the present disclosure. The security device 10 includes a housing 12 having, a first housing component 14 and a second housing component 16. In the exemplified embodiment, the housing components 14, 16 are two separate bodies. At a top side, the housing components 14, 16 are joined by a locking mechanism 30. At a bottom side, the housing components 14, 16 are joined by a hinge 20 such that the components 14, 16 are pivotally coupled. The security device 10 can surround a portion of a product 11 and thereby secure itself to the product 11. In the exemplified embodiment, the product 11 is a baseball bat and the security device 10 is designed to secure to the handle of the baseball bat. In other embodiments, the product 11 can be any object to be secured, including a bottle neck. The security device 10 also includes a release mechanism 50 and an inner ring 18. The inner ring 18 can surround a portion of the product 11 and can comprise a resilient material (e.g., rubber).

In other embodiments, the housing components 14, 16 can be different portions of a single housing body. Further, if the housing components 14, 16, are separate bodies, they can be joined by a device other than a hinge. Further, the inner ring 18 can have a non-circular shape (e.g., a rectangular shape), and/or a non-resilient material, or could be omitted.

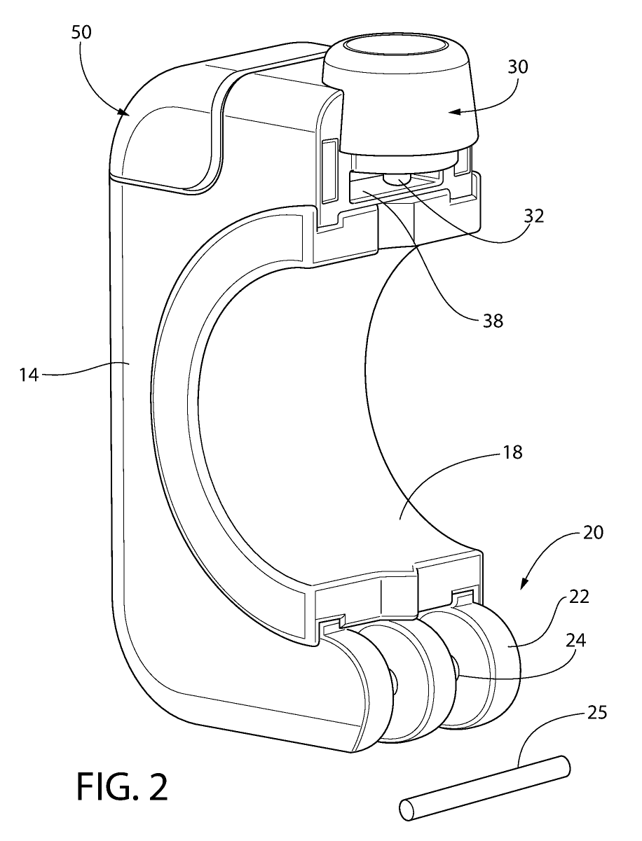

FIG. 2 is a perspective view of the first housing component 14 of FIG. 1. In this embodiment, the locking mechanism 30, release mechanism 50, and a portion of the inner ring 18 can be attached to or form part of the first housing component 14. In other embodiments, the locking mechanism 30 and/or release mechanism 50 can form part of another housing component, such as the second housing component 16. The locking mechanism 30 is shown to include a locking member 32 (e.g., a pin) and a slot 38. These features will be described in more detail below.

The exemplified first housing component 14 further includes components of the hinge 20. Specifically, the exemplified first housing component 14 includes first hinge knuckles 22 having first knuckle openings 24. These first knuckle openings 24 are configured to receive the hinge pin 25. As discussed above, in other embodiments, the hinge 20 can be replaced by another device, or no device.

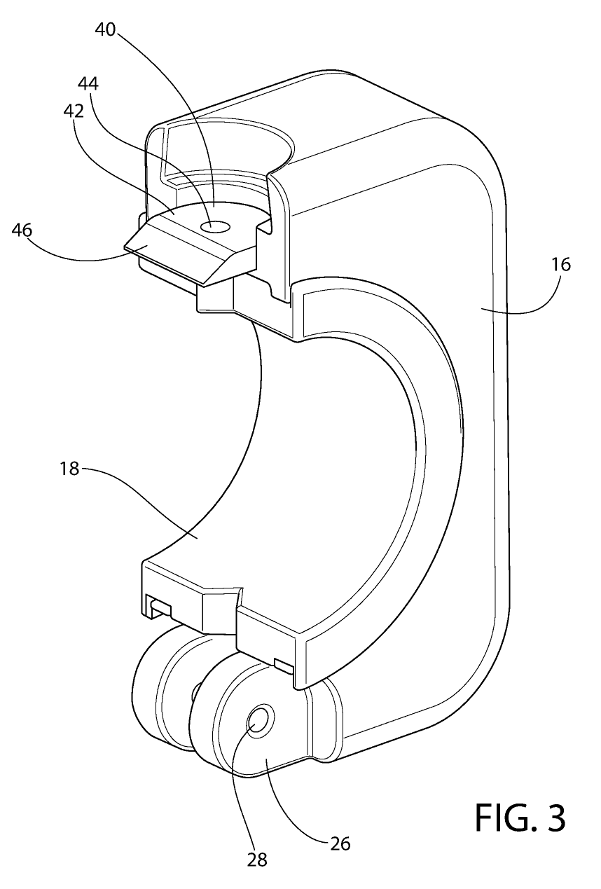

FIG. 3 is a perspective view of the second housing component 16 of FIG. 1. The exemplified second housing component 16 includes a portion of the inner ring 18, as well as a first portion 40. In this embodiment, the first portion 40 of the second housing component 16 is in the form of a tab. The tab 40 is configured to be received by the locking mechanism 30 of the first housing component 14. The tab 40 includes a tab first surface 42, a tab depression 44 in the tab first surface 42, and a tab inclined surface 46. In other embodiments, the first portion 40 can take different shapes and/or can form part of another housing component, such as the first housing component 14.

The exemplified second, housing component 16 can thither include additional components of the hinge 20. For example, the exemplified second housing component 16 can include second hinge knuckles 26 having second knuckle openings 28, the second knuckle openings 28 configured to receive the hinge pin 25 of FIG. 2.

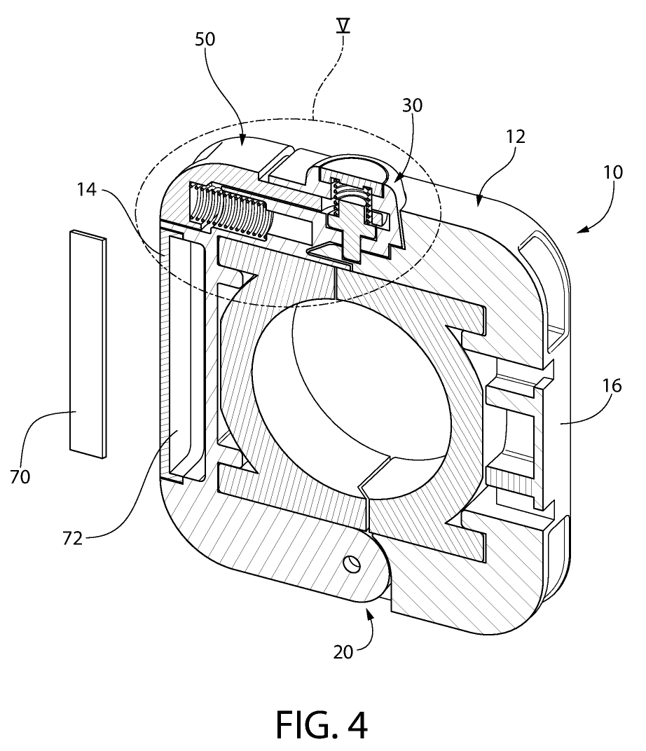

FIG. 4 is a sectional view of the security device 10 of FIG. 1 taken along line IV. This view shows the first housing component 14 joined to the second housing component 16 via the locking mechanism 30 and the hinge 20. It further shows the release mechanism 50.

The exemplified security device 10 further includes an electronic article surveillance (EAS) cavity 72 in the housing 12 of the security device 10. An EAS component 70 can be positioned in the EAS cavity 72 (entirely or partially). In the exemplified embodiment, the EAS component 70 is an acousto-magnetic tag that can resonate in response to an electromagnetic field, thereby causing an EAS gate to alarm. In other embodiments, the EAS component 70 can be any device for providing electronic security, including devices incorporating radio frequency, magnetic, or RFID (active or passive) technology.

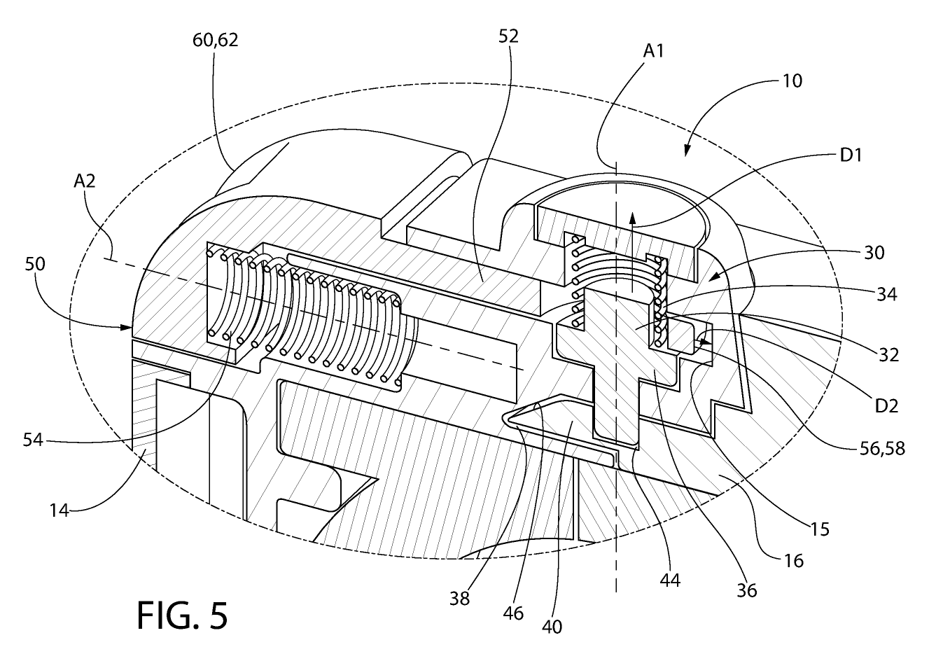

FIG. 5 is an enlarged view of section V of FIG. 4, showing the locking mechanism 30 and release mechanism 50. This view provides a closer look at the locking mechanism 30 and release mechanism 50 of the exemplified security device 10. In the exemplified embodiment, the locking mechanism 30 is in a locked state in which the locking mechanism 30 is configured to lock the tab 40 of the second housing component 16 to the first housing component 14. In the unlocked state, the tab 40 of the second housing component 16 is unlocked from and separable from the first housing component 14. Further, the locking mechanism 30 is configured to alternate between the locked state and the unlocked state. Accordingly, the locking mechanism 30 can lock the security device 10 to a product, be removed from the product, and be attached to another product (or the same product) without destroying or otherwise undermining the integrity of the security device 10 or its operation.

In the exemplified embodiment, the locking mechanism 30 can include a locking member 32 in the form of a pin. The locking member 32 is configured to move between (a) a locked position to place the locking mechanism 30 in the locked state and thereby secure the security device 10 to a product, and (b) an unlocked position to place the locking mechanism 30 in the unlocked state to allow the removal of the security device 10 from the product. Specifically, the locking member 32 can be configured to move in a first direction D1 to alternate from the locked position to the unlocked position. The locking mechanism 30 can include a first biasing member 34 configured to bias the locking member 32 in the locked position The first biasing member 34 can be a spring or another component providing biasing. In the exemplified embodiment, the locking member 32 comprises a conductive material configured to, move in the first direction D1 in response to a magnetic force. Thus, a magnetic detacher placed above the security device 10 can attract the locking member 32 and thereby move the locking member 32 in the first direction D1 to the unlocked position. In the exemplified embodiment, the locking member 32 forms part of the first housing component 14. In other embodiments, the locking member 32 can form part of another housing component, such as the second housing component 16. Further, the locking member 32 can comprise one object or plurality of objects working together to perform the locking and unlocking functions described herein.

In the exemplified embodiment, the tab can be configured to be received, by the slot 38 of the first housing component 14. When the housing components are brought together and the tab enters the slot 38, the tab inclined surface 46 can move the locking member 32 in the first direction D1 along the first axis A1, temporarily overcoming the downward force provided by the first biasing member 34. When the bottom of the locking member 32 is aligned with the tab depression 44, the first biasing member 34 can provide a force to push the locking member 32 down into the tab depression 44. At this stage, the locking member 32 is in the locked position.

FIG. 5 further shows a release mechanism 50 according to one embodiment. The release mechanism 50 comprises a release member 52. The release member 52 is configured to alternate between a blocked position and a release position. In the blocked position the release member 52 blocks the locking mechanism 30 from entering the unlocked state, and in the release position the release member 52 allows the locking member 32 to enter the unlocked state. Since the release member 52 can alternate between the blocked position and the release position, the release member 52 can switch between blocking and not blocking the locking member 32 without destroying or otherwise undermining the integrity of the security device 10 or its operation. The release member 52 can comprise a single object or multiple objects working together to perform the blocking and release functions described herein.

In the exemplified embodiment, in the blocked position the release member 52 can block the locking member 32 from moving in the first direction D1, and in the release position the release member 52 can allow the locking member 32 to move in the first direction D1. By blocking the locking member 32 from moving in the first direction D1, the release member 52 can prevent the locking member 32 from achieving the unlocked position, and thereby prevent the security device 10 from being removed from a product. Conversely, when the release member 52 is in the release position, the locking member 32 can move in the first direction D1 and achieve the unlocked position, and thereby allow the removal of the security device 10 from the product.

In the exemplified embodiment, the release member 52 blocks and allows the movement of the locking member 32 as follows. The release member 52 has a first end 56 and a second end 60, the first end 56 being opposite the second end 60. The first end 56 has a blocking portion 5$, and the second end 60 has a push-button portion 62. Further, the locking member 32 includes a transverse portion 36. In the blocked position, the blocking portion 58 of the release member 52 blocks the transverse portion 36 of the locking member 32 from moving in the first direction D1. A second biasing member 54 extends along a second axis A2 and is configured to bias the release member 52 in the blocked position. The second biasing member 54 can be a spring or another component providing biasing. The biasing force of the second biasing member 54 can be overcome by a force being applied on the biasing member in a second direction D2. This force can be applied by a user pressing the push-button portion 62 in the second direction D2. When such a force is applied, the release member 52 can achieve a release position in which the release member 52 allows the transverse portion 36 of the locking, member 32 to move in the first direction D1.

The exemplified release member 52 is configured to move in a second direction D2 that is perpendicular to the first direction D1 of the locking member 32. The release member 52 is configured to move in the second direction D2 until contacting, a first wall 15 of the first housing and thereby achieving the release position. In the blocked position, the release member 52 is configured to block the transverse portion 36 of the locking member 32 from moving in the first direction D1. In the release position, the release member 52 is configured to allow the transverse portion 36 to move in the first direction D1 and thereby enable the locking mechanism 30 to achieve the unlocked state. The exemplified release member 52 can surround the transverse portion 36 of the locking member 32 when the release member 52 is in the release position and the locking member 32 is in the unlocked position. Further, the exemplified release member 52 does not surround the transverse portion 36 of the locking member 32 when the release member 52 is in the blocked position. FIG. S shows the security device 10 when the release member 52 is blocking the locking member 32 from moving in the first direction D1.

In other embodiments, the second direction D2 (the direction of movement of the release member 52) can be other than perpendicular to the first direction D1 (the direction of movement of the locking member). In other embodiments, the release mechanism 50 can use other methods of blocking and allowing the locked state and unlocked state of the locking mechanism.

In the exemplified embodiment, the release mechanism 50 and its release member 52 form part of the first housing component 14. In other embodiments, the release mechanism 50 and release member 52 can form part of another housing component, such as the second housing component 16.

The exemplified security device can be used as part of a method of attaching and removing a security device from a product. For example, such a method can include placing the security device around, a portion of the product; attaching the security device to the portion of the product by locking the second housing component to the first housing component; and removing the security device from the product by moving the release member to the release position and the locking mechanism to the unlocked state.

The exemplified security device provides several advantages. For example, some security devices can be defeated by striking the locking mechanism against the ground or a hard surface. If the security device does not include a release mechanism, the force from striking the locking mechanism can cause a locking member to move and overcome the force of a biasing member, thereby moving the locking member into an unlocked position. If the inner ring is made of a resilient material that is tightly squeezing a product, even a brief movement of moving the locking member into the unlocked position will cause the resilient inner ring to expand, thereby separating the first housing component from the second housing component and placing the security device in the unlocked state. The release mechanism described herein can prevent a shoplifter or other person from defeating a security device in this manner. If a person struck the locking mechanism in an attempt to move the locking member into the unlocked position, the release member can block the locking mechanism from moving into the unlocked position.

While the various example embodiments have been described with respect to specific examples, those skilled in the art will appreciate that there are numerous variations and permutations of the above that may be implemented without departing from the scope of the present invention. Also, it is to be understood that other embodiments may be utilized and structural and functional modifications may be made without departing from the scope of the present invention. Thus, the spirit and scope should he construed broadly as set forth in the appended claims.

1. A security device comprising:
a first housing component
a second housing component;
a locking mechanism comprising a locking member configured to alternate between a locked position and an unlocked position, wherein:
in the locked position the locking member is configured to transition the locking mechanism into a locked state and lock a first portion of the second housing component to the first housing component and thereby secure the security device to a product; and
in the unlocked position the locking member is configured to transition the locking mechanism into an unlocked state and the first portion of the second housing component is unlocked from and separable from the first housing component thereby enabling removal of the security device from the product;
a release member configured to alternate between a blocked position and a release position, wherein:
in the blocked position the release member blocks the locking member from moving to the unlocked position; and
in the release position the release member allows the locking member to move to the unlocked position; and
an electronic article surveillance (EAS) component in a cavity of the first housing component or the second housing component;
wherein the locking member and the release member are both affixed to the first housing component when the locking mechanism is in the unlocked state.

2. The security device of claim 1 wherein the locking member is configured to move in a first direction to transition from the locked position to the unlocked position;
wherein, in the blocked position, the release member blocks the locking member from moving in the first direction; and
wherein, in the release position, the release member allows the locking member to move in the first direction.

3. The security device of claim 2:
wherein the locking mechanism comprises a first biasing member configured to bias the locking member in the locked position; and
wherein a second biasing member is configured to bias the release member in the blocked position.

4. (canceled)

5. (canceled)

6. The security device of claim 1 wherein the first housing component and the second housing component are pivotally coupled via a hinge.

7. The security device of claim 1 further comprising an inner ring coupled to an interior of the housing, the inner ring comprising a resilient material.

8. The security device of claim 2 wherein the first portion of the second housing component comprises a tab, wherein the tab is configured to be received by a slot of the first housing component, and the tab comprises a depression configured to receive the locking member.

9. The security device of claim 8 wherein the tab comprises an inclined surface configured to move the locking member in the first direction when the tab enters the slot.

10. The security device of claim 9 wherein the locking member is a pin.

11. The security device of claim 2 wherein the locking member comprises a conductive material configured to move in the first direction in response to a magnetic force.

12. The security device of claim 2 wherein the locking member comprises a transverse portion and wherein:
in the blocked position the release member blocks the transverse portion of the locking member from moving in the first direction; and
in the release position the release member allows the transverse portion of the locking member to move in the first direction.

13. The security device of claim 12 wherein the release member is configured to move in a second direction that is perpendicular to the first direction of the locking member.

14. The security device of claim 13 wherein the first housing component comprises a first wall, and wherein the release member is configured to move in the second direction until contacting the first wall to thereby achieve the release position.

15. The security device of claim 14 wherein the release member is configured to:
surround the transverse portion of the locking member when the release member is in the release position and the locking member is in the unlocked position; and
not surround the transverse portion of the locking member when the release member is in the blocked position.

16. The security device of claim 15 wherein the release member comprises:
a blocking portion at a first end of the release member, the blocking portion configured to block the transverse portion of the locking member from moving in the first direction; and
a push-button portion at a second end of the release member, the push-button portion configured to receive from a user a force in the second direction;
wherein the first end is opposite the second end.

17. A method of attaching and removing a security device from a product, the method comprising:
placing the security device around a portion of the product, the security device comprising:
a first housing component
a second housing component;
a locking mechanism comprising a locking member configured to alternate between a locked position and an unlocked position, wherein:
in the locked position the locking member is configured to transition the locking mechanism into a locked state and lock a first portion of the second housing component to the first housing component and thereby secure the security device to the product; and
in the unlocked position the locking member is configured to transition the locking mechanism into an unlocked state and the first portion of the second housing component is unlocked from and separable from the first housing component thereby enabling removal of the security device from the product;
a release member configured to alternate between a blocked position and a release position, wherein:
in the blocked position the release member blocks the locking member from moving to the unlocked position; and
in the release position the release member allows the locking member to move to the unlocked position; and
an electronic article surveillance (EAS) component in a cavity of the first housing component or the second housing component;
attaching the security device to the portion of the product by locking the second housing component to the first housing component;
removing the security device from the product by moving the release member to the release position and the locking mechanism to the unlocked state.

18. The method of claim 17 wherein the locking member is configured to move in a first direction to alternate from the locked position to the unlocked position;
wherein, in the blocked position, the release member blocks the locking member from moving in the first direction; and
wherein, in the release position, the release member allows the locking member to move in the first direction.

19. The method of claim 17 wherein the locking member comprises a transverse portion, and wherein:
in the blocked position, the release member blocks the transverse portion of the locking member from moving in a first direction; and
in the release position, the release member allows the transverse portion of the locking member to move in the first direction.

20. A security device comprising:
a housing comprising a first housing component and a second housing component;
a locking member forming part of the first housing component and configured to alternate between a locked position and an unlocked position, the locking member configured to move in a first direction to alternate from the locked position to the unlocked position; wherein:
in the locked position the locking member is configured to lock a tab of the second housing component to the first housing component and thereby secure the security device to a product; and
in the unlocked position the tab of the second housing component is unlocked from and separable from the first housing component thereby enabling removal of the security device from the product;
a first biasing member configured to bias the locking member in the locked position;
a release member forming part of the first housing component and configured to alternate between a blocked position and a release position, wherein:
in the blocked position the release member blocks the locking member from moving in the first direction; and
in the release position the release member allows the locking member to move in the first direction;
a second biasing member configured to bias the release member in the blocked position; and
an electronic article surveillance (EAS) component in a cavity of the housing;
wherein the first housing component and the second housing component are pivotally coupled via a hinge;
wherein the tab of the second housing component is configured to be received by a slot of the first housing component, and the tab comprises a depression configured to receive the locking member;
wherein the locking member comprises a transverse portion;
wherein in the blocked position the release member blocks the transverse portion of the locking member from moving in the first direction;
wherein in the release position the release member allows the transverse portion of the locking member to move in the first direction;
wherein the locking member and the release member are both affixed to the first housing component when the locking member is in the unlocked state.
